(19) United States
(12) Patent Application Publication
(10) Pub. No.: US 2012/0237915 A1
(43) Pub. Date: Sep. 20, 2012

(54) SYSTEM AND METHOD FOR ASSESSMENT TESTING

(76) Inventors: ERIC KROHNER, FARMINGTON HILLS, MI (US); CHRIS CUNNINGHAM, HIXSON, TN (US); RICHARD STUHLSATZ, WASHINGTON, MI (US); MATTHEW LEESE, WESTLAND, MI (US)

(21) Appl. No.: 13/209,492

(22) Filed: Aug. 15, 2011

Related U.S. Application Data
(60) Provisional application No. 61/453,353, filed on Mar. 16, 2011.

(51) Int. Cl. G09B 7/00

(52) U.S. Cl. 434/323

(57) ABSTRACT

A competency assessment method for evaluating at least one capability on of an individual seeking or holding a job with a specified employer includes assessing a plurality of competencies to determine the degree to which each competency is able to predict whether the individual possesses the capability without regard to the nature or industry of the job with the specified employer; selecting a subset of the competencies based on ability of each competency to predict whether the individual possesses the capability; accepting as input at least one user-generated assessment that is relevant to each competency of the subset of competencies; and generating as output a score indicative of the individual's capability based on the at least one user-generated assessment.

### CROSS-REFERENCE TO RELATED APPLICATIONS

This application claims the benefit of U.S. Provisional Application No. 61/453,353, filed on Mar. 16, 2011, which is incorporated by reference.

### TECHNICAL FIELD

The disclosure relates to the field of assessment testing, and more particularly, to a system and method for assessment testing.

### BACKGROUND

Across many industries, businesses and other organizations strive to meet the requirements of a competitive marketplace and other challenges. For example, many business strive to provide excellent service to customers and clients. Whatever a business or other organization's objectives, it is often useful to recruit, hire and appropriately train employees, contractors, students, volunteers or others who are capable of meeting these objectives through the performance of their responsibilities. Training programs and talented managers are components of these efforts. Research and experience have shown, however, that some persons are better suited for employment in service positions than others.

For example, during a typical hiring process, a job candidate is interviewed to determine whether the candidate would be able to competently perform the duties associated with the position. In service oriented fields, traditional interviewing techniques tend to be poor indicators of a candidate's ability to provide excellent service to customers or clients.

As an example, a candidate's responses to questions posed by a prospective employer might better reflect the candidate's perception as to what the “correct” answers are, rather than being sincere and genuine answers. Such answers provide little insight to the actual opinions and attitudes of the candidate toward providing service and provide no insight as to the emotional and behavioral capacity of the Applicant to provide excellent service to customers or clients.

Assessment testing has long been used as a tool for screening potential job candidates. Often, however, these tests are overly complex, lengthy, and fail to fully engage the candidate, which leads to test-taking fatigue, disinterest, and drop-off.

### SUMMARY

Disclosed herein are embodiments of systems and methods for assessment testing.

One aspect of the disclosed embodiments is a universal competency assessment method for evaluating at least one capability on of an individual seeking or holding a job with a specified employer includes assessing a plurality of competencies to determine the degree to which each competency is able to predict whether the individual possesses the capability without regard to the nature or industry of the job with the specified employer; selecting a subset of the competencies based on ability of each competency to predict whether the individual possesses the capability; accepting as input at least one user-generated assessment that is relevant to each competency of the subset of competencies; and generating as output a score indicative of the individual's capability based on the at least one user-generated assessment.

Another aspect of the disclosed embodiments is a method for evaluating at least one capability of an individual seeking or holding a job with a specified employer. The method includes providing a plurality of images including at least one graphic element depicting a service provider, at least one graphic element depicting a customer of the specified employer, and at least one graphic element depicting an environment that at least partially represents a facility used by the specified employer, wherein at least one of the plurality of images depicts a visual attribute of the specified employer; generating a composite image including the plurality of images, the composite image depicting a work scenario occurring at least in part at the facility used by the specified employer; causing the composite image to be displayed with at least one question pertaining to the work scenario and a plurality of candidate responses to the at least one question; accepting as input at least one user-generated assessment of at least one of the plurality of candidate responses; and generating as output a score indicative of the individual's capability based on the at least one user-generated assessment.

Another aspect of the disclosed embodiments is a computer-implemented method for testing at least one capability of an individual. The method includes displaying on a computer monitor a plurality of attributes previously associated with the capability; accepting as a first input for each of the plurality of attributes the individual's assessment of the relative importance of the attribute to the capability; displaying on a computer monitor a graphic image depicting an exercise related to the capability; displaying text describing a plurality of alternative actions that could be taken in connection with the exercise; accepting as a second input an assessment by the individual with respect to each of the plurality of alternative actions; displaying on the computer monitor a plurality of graphic images each depicting a potential outcome to at least one of the plurality of alternative actions; accepting as a third input an assessment by the individual of the likelihood-of-occurrence of each potential outcome; displaying on the computer monitor a plurality of activities associated with the capability, wherein at least some of the activities require for their proper performance at least one or more of the plurality of attributes; accepting as a fourth input a user-generated indication of the individual's experience in performing each of the plurality of activities; and generating as output a score indicative of the individual's capability based on the first, second, third and fourth inputs.

Another aspect of the disclosed embodiments is a computer-implemented method for evaluating at least one capability of an individual seeking or holding employment. The method includes displaying on a monitor a graphic stimulus, a textual question pertaining to the graphic stimulus and a plurality of responses to the textual question; displaying on the monitor at least one representation of a control element which is movable in response to a user-actuated input device to one or more positions each indicative of a user-generated assessment; accepting as input at least one user-generated assessment for at least one of the plurality of responses; and generating as output a score indicative of individual's capability based on the user-generated assessment.

Another aspect of the disclosed embodiments is a method for evaluating at least one capability on of an individual seeking or holding a job with a specified employer. The method includes defining a plurality of attributes that are associated with the capability; accepting an attribute ranking input representing a user generated assessment of the relative importance of each of the plurality of attributes; displaying a plurality of scenarios; accepting one or more scenario inputs representing user generated responses to the plurality of scenarios, wherein the scenario inputs are relevant to one or more of the attributes; accepting an experience input representing a user generated indication of the individual's experience in performing each of a plurality of activities, wherein at least some of the activities require for their proper performance at least one or more of the plurality of attributes; and generating as output a score indicative of the individual's capability based on the attribute ranking input, the scenario inputs and the experience input.

Another aspect of the disclosed embodiments is a computer-implemented method for evaluating at least one capability of an individual seeking or holding employment with a specified employer. The method includes the steps of displaying on a computer monitor a graphic image depicting an interaction between a service provider and a customer of the employer; displaying text describing a plurality of alternative actions that could be taken by the individual during the depicted interaction; accepting as a first input an assessment with respect to each of the plurality of alternative actions; displaying on the computer monitor a plurality of graphic images each depicting a potential reaction by the customer to at least one of the plurality of alternative actions; accepting as a second input an assessment by the individual of the likelihood-of-occurrence of each potential reaction; and generating as output a score indicative of individual's capability based on the first input and the second input.

### BRIEF DESCRIPTION OF THE DRAWINGS

The description herein makes reference to the accompanying drawings wherein like reference numerals refer to like parts throughout the several views, and wherein:

FIG. 1 is a diagram showing an assessment testing system implemented in an exemplary environment;

FIG. 2 is an illustration showing an ideal service provider evaluation screen of the assessment system;

FIG. 3 is an illustration showing a first service scenario screen;

FIG. 4 shows a second service scenario screen;

FIG. 5 is an illustration showing a self evaluation screen;

FIG. 6 is an illustration showing a grouping of slider bar controls;

FIG. 7A is a graphical representation of a service scenario illustrating relative placement of a customer and a service provider;

FIG. 7B is an illustration showing a graphical service scenario, wherein company-specific branding is applied;

FIG. 8A shows a background element of the graphical service scenario;

FIG. 8B shows a service provider element of the graphic service scenario;

FIG. 8C shows a customer element of the graphical service scenario;

FIG. 8D shows compositing of the background, the service provider element, and the customer element to produce the final graphical service scenario;

FIG. 9 is a flow chart showing a method for evaluating at least one capability of an individual seeking or holding a job with a specified employer;

FIG. 10 is a flow chart showing a computer-implemented method for testing at least one capability of an individual;

FIG. 11 is a flow chat showing a computer-implemented method for evaluating at least one capability of an individual seeking or holding employment;

FIG. 12 is a flow chart showing a method for evaluating at least one capability of an individual seeking or holding a job with a specified employer;

FIG. 13 is a flow chart showing a method for evaluating at least one capability of an individual seeking or holding a job with a specified employer;

FIG. 14 is a flow chart showing a method for evaluating at least one capability of an individual seeking or holding a job with a specified employer; and

FIG. 15 is a block diagram showing an exemplary computer system.

### DETAILED DESCRIPTION

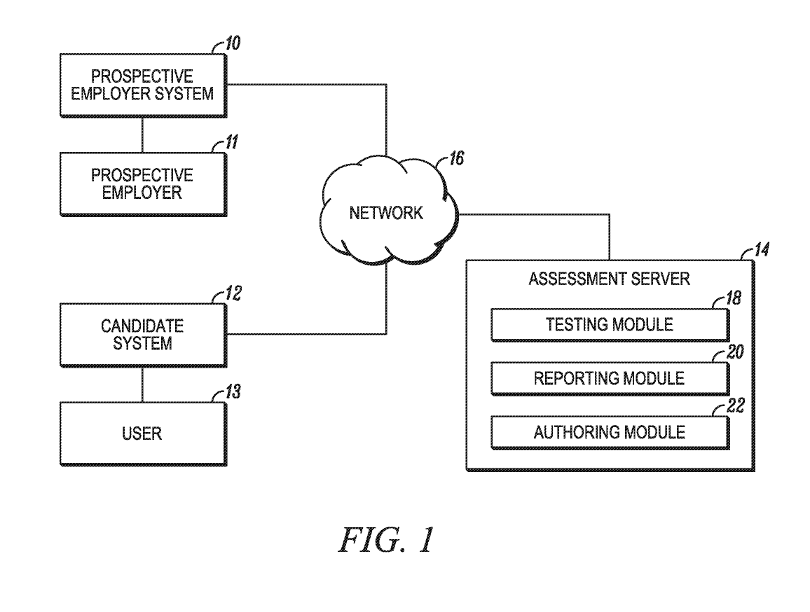

FIG. 1 is a diagram showing a system and method for assessment testing implemented in an exemplary environment. A prospective employer system 10, a candidate system 12, and an assessment server 14 are connected to one another by a network 16. Each of these systems may be a single system or multiple systems. The network 16 allows communication between them in any suitable manner. In one exemplary embodiment, the prospective employer is a service provider engaged in a customer service business such as a retail store, hotel or almost any other type other business that seeks to hire and train its employees to provide to good customer service. The system and method taught herein is also useful for any type of organization that seeks to recruit, hire, train, manage and/or deploy people to perform a function (such as leadership, management, service or safety) at a certain level of competency. It is not limited to for-profit businesses. For example, government agencies such as police and fire departments as well as not-for-profit groups such as schools and charities can use the systems and methods taught herein with respect to their employees, students, and/or volunteers. The term “employer” thus refers to any such business, government agency, sports team or other organization that recruits, trains, manages and/or deploys people Likewise, the term “employee” refers to any employee, contractor, student, volunteer, or other person who is being recruited, trained, managed or deployed by an employer. The term “job” means any set of responsibilities, paid or unpaid, whether or not part of an employment relationship, that need to be performed competently.

In one exemplary embodiment, the assessment testing described herein is directed to the prospective employees ability to provide good customer service. Any other aptitudes and abilities can be tested as well, such as a prospective employee's ability to perform a job safely or ability to be an effective leader or to work with attention to detail Likewise, both prospective and current employees can be tested. For example, current employees can be tested to for purposes of determining new assignments for the current employees.

The assessment server 14 is provided with assessment software including a testing module 18, a reporting module 20, and an authoring module 22. The testing module 18, the reporting module 20, and the authoring module 22 each include computer executable instructions that, when executed, perform functions that will be explained herein. In the context of the testing module 18, the reporting module 20, and the authoring module 22, the term “module” refers to a set grouping of related functions. Each “module” can be implemented as a single software program, a set of related software programs, or as part of a software program including additional related or unrelated functionality. All of the “modules” described herein can be implemented in a single software program.

The testing module 18 is invoked when the assessment server 14 is accessed by the candidate system 12. The testing module 18 is operable to generate an assessment test, which is delivered to the candidate system 12 by the assessment server 14. The candidate system 12 receives the assessment test from the assessment server 14 and displays the assessment test using appropriate software, such as a web browser, a specialized software client, or other suitable software. During administration of the assessment test by the candidate system 12, the candidate system 12 receives input from a user 13 and transmits the user input to the assessment server 14. As one example, the user 13 can be seeking or holding employment with a specified employer, such as a prospective employer 11. In other examples, the user 13 can be in a role other than that of seeking or holding employment with a specified employer 11, such as a person wishing to volunteer for a non-profit. Thus, while terms such as “candidate”, “employee”, and “employer” are used for purposes of explanation, these terms are not meant to imply that use of the system is limited to this specific context.

The assessment test can be delivered to the candidate system 12 by the assessment server 14 in the form of a web application that includes one or more web pages. These web pages are displayed by candidate system 12, and request input from the user 13 of the candidate system 12.

During administration of the assessment test, the testing module 18 presents a series of stimuli to the user 13 of the candidate system 12 and receives from the candidate system 12 an input in response to each stimulus. These stimuli can be presented as web page screens that are displayed to the user by the candidate system 12. The various web page screens are operable to receive user input in response to the stimuli, and to cause the candidate system 12 to transmit the input to the assessment server 14. The input is utilized to rate the ability of the user 13 to provide service to customers of the prospective employer 11, as will be explained in detail herein.

On first accessing the testing module 18, a biographical information input screen is transmitted to the candidate system 12 by the assessment server 14. The biographical information input screen asks the user 13 of the candidate system 12 to provide biographical information to the testing module 18. This biographical information can include information that is sufficient to allow the prospective employer 11 to identify and contact the user 13 after the assessment test is completed. The biographical information input screen is operable to receive the biographical information and to cause the candidate system 12 to transmit the biographical information to the assessment server 14. The biographical information can be stored by the assessment server 14 in a secure format in order to protect the privacy of the user of the candidate system 12.

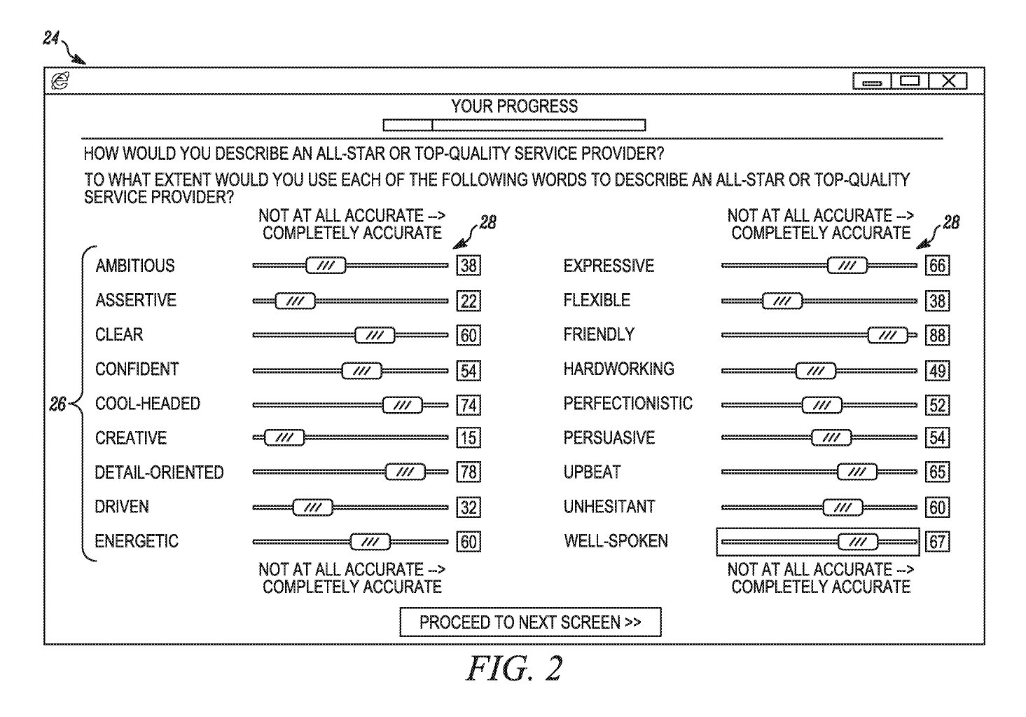

The assessment test can include assessment of the past experiences of the user 13 of the candidate system 12. In order to receive input describing the past experiences of the user 13 of the candidate system 12, the assessment test includes a past experiences input screen, as shown in FIG. 2. The past experiences input screen is generated by the testing module 18 and is transmitted to the candidate system 12 by the assessment server 14.

The past experiences input screen includes one or more past experiences questions, each identifying an activity. For each of the past experiences questions, the past experiences input screen accepts a past experiences input from the user 13 of the candidate system 12 regarding the activity. The activities included on the past experiences input screen are customer service or client service activities, activities that in some way relate to customer service or client service, or activities that serve as predictors of aptitude for customer service or client service. The activities can pertain to a previous work environment or can pertain to experience servicing others outside of a work environment. By providing the past experiences inputs, the user 13 of the candidate system 12 is rating his or her own level of past service experience.

Various formats can be utilized for the past experience inputs. Each past experience input can be a selection from a set of predefined answers. Alternatively, each past experiences input can be a numeric input. Each past experience input can be a separate input control, such as a text field, a list box, a combo box, or a radio button. As another example, each past experience input can be a slider control that allows the user 13 of the candidate system 12 to slide an indicator continuously along a value range having a minimum value and a maximum value, as will be explained in detail herein.

The assessment test includes assessment of the attitudes of the user 13 of the candidate system 12 regarding the qualities that an ideal service provider possesses. As shown in FIG. 2, an ideal service provider evaluation screen 24 is presented to the user of the candidate system 12. The ideal service provider evaluation screen 24 tasks the user 13 of the candidate system 12 with rating a variety of personality qualities 26 in terms of their accuracy as descriptors of an extrinsic ideal service provider. These attributes are personality attributes that have been previously associated with a capability that is relevant to the performance of the job for which the user of the candidate system 12 is applying. The attributes, however, can be non-industry specific, such that the assessment test can be applied in different contexts without modifying the attributes. The attributes can be a subset of attributes that are selected by analyzing a plurality of attributes with respect to their correlation to the capability, where the subset is selected based on a high correlation between the attribute and the capability. The resulting subset of attributes can be used as the basis of an assessment that is universally competent, i.e. the assessment can be deployed across multiple positions and industries without modification.

An input control 28 is associated with each of the personality qualities 26. Each input control 28 accepts an input from the user of the candidate system 12 that represents an assessment by the user as to the relative importance of that attribute to the performance of the job. The user's responses are indicated using the input controls 28, are transmitted to the assessment server 14, and are stored and processed by the testing module 18.

The assessment test also includes an assessment of the ability of the user 13 of the candidate system 12 to make appropriate judgments in service situations, and to understand the likely effect of his or her actions in those situations. These scenarios can relate to the performance of a customer service or client service related task or performance of an internal service related task. Examples of internal service related tasks include interactions with coworkers, supervisors, and/or managers.

The user 13 is guided through a series of service judgment scenarios. Each service judgment scenario includes a plurality of service scenario screens. Each service scenario screen is generated by the testing module 18, transmitted to the candidate system 12 by the assessment server 14, and displayed to the user 13 by the candidate system 12.

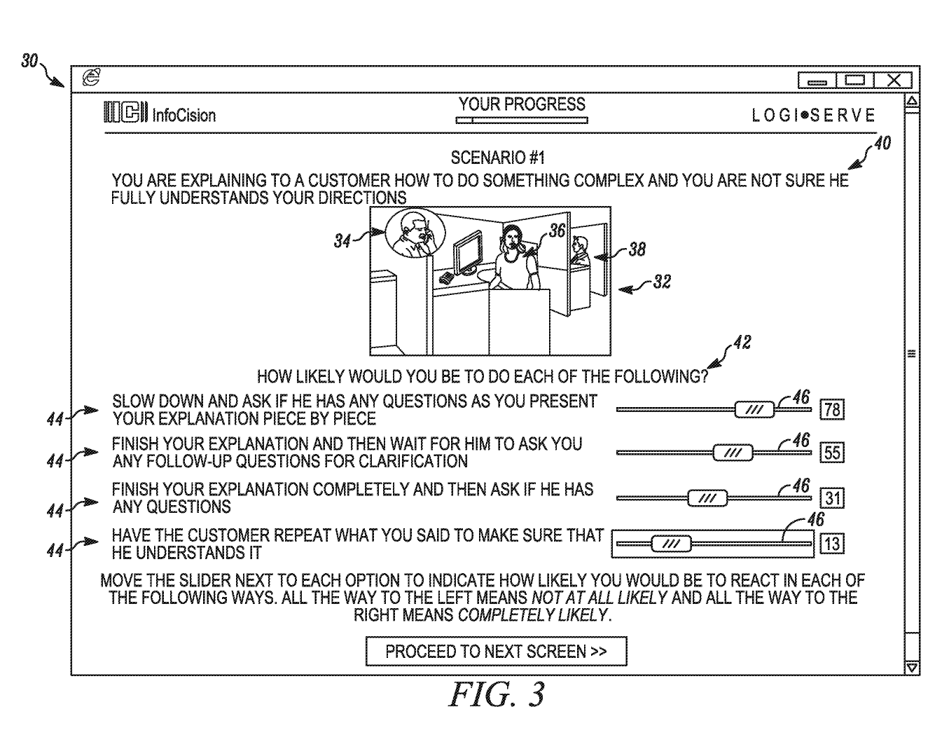

A first service scenario screen 30 is presented to the candidate system 12 by the assessment server 14, as shown in FIG. 3. The first service scenario screen 30 includes a graphical representation 32 of a service judgment scenario. The graphical representation 32 includes depictions of a customer 34 and a service provider 36 in an environment 38, as will be explained further herein. The terms “customer” and “service provider” are used broadly herein. The term “customer” refers to any person being served, aided, assisted, etc., regardless of whether revenue is generated by the transaction, and includes both internal customers and external customers or clients. The term “service provider” refers to any person who is serving, aiding, assisting, etc. As an example, the service provider 36 could be a sales associate and the customer 34 could be an external customer who is attempting to purchase goods or services. As another example, the service provider 36 could be a manager and the customer 34 could be an employee who is being managed by the service provider 36. In this example, the assessment testing could be directed toward assessing leadership ability.

As yet another example, the service provider 36 could be a policeman and the “customer” 34 could be a criminal being arrested. In that case, the assessment testing could be directed toward asserting authority, adhering to police department policies, or remaining calm in dangerous situations. Along with the graphical representation 32, the candidate system 12 is presented with a scenario description 40. The scenario description 40 is provided with the graphical representation 32, in order to explain the situation that is occurring in the scene depicted by the graphical representation 32. The scenario description 40 can be a textual description of a situation that is occurring during an interaction between the customer 34 and the service provider 36, as represented in the graphical representation 32, which can be positioned near or adjacent to the scenario description 40. As an alternative, the scenario description 40 can be in the form of audio that is played when the graphical representation 32 is presented. In example illustrated in FIG. 3, the scenario description 40 indicates that the service provider is explaining to a customer how to perform a complex task and that the service provider 36 is not sure that the customer 34 understands the directions that are being given.

The first service scenario screen 30 also includes a judgment question 42 that relates to the graphical representation 32 and the scenario description 40. The first service scenario screen 30 is configured to accept a response to the judgment question 42 from the user 13 of the candidate system 12. The judgment question 42 can be in the form of a query as to how likely the user 13 of the candidate system 12 would be to respond in a manner described by each of a plurality of candidate responses 44.

Each of the candidate responses 44 includes a description of the manner in which the service provider 36 would respond to the scenario. As input, the first service scenario screen 30 is configured to accept a user-generated assessment relating to each of the candidate responses. In the example illustrated in FIG. 3, one of the candidate responses 44 explains that the service provider 36 would slow down and ask if the customer 34 has any questions as the service provider 36 explains the instructions piece by piece.

Associated with each candidate response 44 is an input control 46 that allows the user 13 of the candidate system 12 to input their assessment as to the likelihood that they would respond in the manner specified by the candidate response 44. The user's responses are indicated using the input controls 46, are transmitted to the assessment server 14, and are stored and processed by the testing module 18.

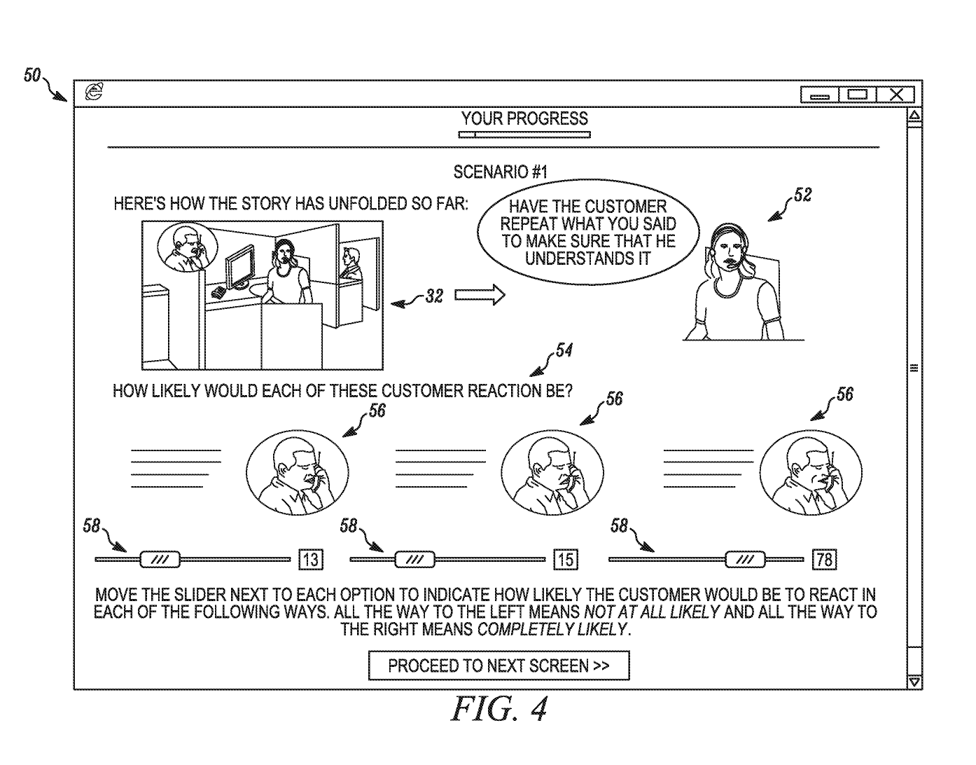

After the user responds to the judgment question 42 of the first service scenario screen 30, a second service scenario screen 50 is displayed, as shown in FIG. 4. The second service scenario screen 50 includes a summary of the scenario and an identified response 52, showing the manner in which the service provider 36 will respond. The identified response 52 can correspond to the response that the user 13 of the candidate system 12 indicated as being their most likely response in the first service scenario screen 30.

The second service scenario screen 50 includes a reaction question 54. The reaction question 54 is made with respect to one or more potential customer reactions 56. The reaction question 54 can ask the user to assess each of the potential customer reactions 56. As an example, the reaction question 54 can ask the user to indicate how likely they believe each potential customer reaction 56 would be using an input control 58. As an example, three potential customer reactions could be presented on the second service scenario screen, in which case, the user 13 is asked to rate the likelihood of each of the potential customer reactions 56. The user responses are indicated using the input controls 58, are transmitted to the assessment server 14, and are stored and processed by the testing module 18.

After completion of the second service scenario screen 50, the user 13 of the candidate system 12 can be presented with a final screen that provides a summary of the scenario, the identified response 52, and the potential customer reaction 56 that the user of the candidate system 12 indicated was most likely to occur.

The assessment test can proceed by presenting additional service judgment scenarios to the user of the candidate system 12. The user's responses regarding each scenario are transmitted to the assessment server 14 and are stored and tracked by the testing module 18. The scenarios can be designed such that these responses are relevant to the personality attributes that were profiled in the context of the ideal service provider evaluation screen 24.

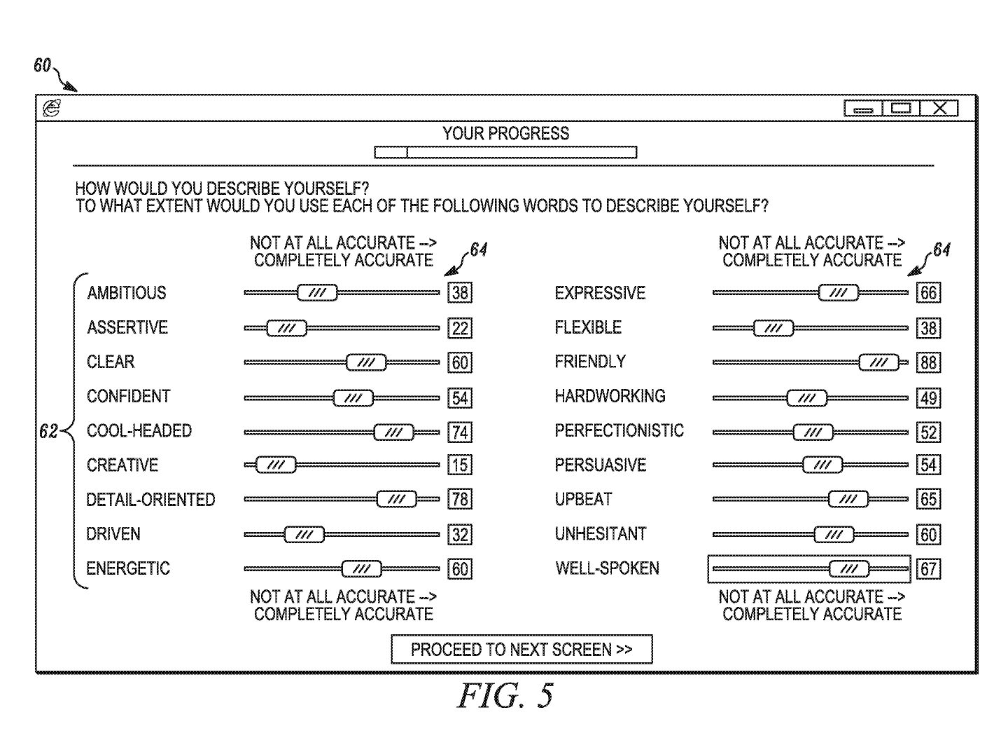

The assessment test includes self assessment of the user's perception of his or her own personality qualities. As shown in FIG. 5, a self evaluation screen 60 is presented to the user 13 of the candidate system 12. The self evaluation screen 60 tasks the user with rating themselves with respect to a plurality of personality qualities 62 that are associated with performance of the job for which the user is applying. An input control 64 is associated with each of the personality qualities 26. Each input control 64 accepts an input from the user of the candidate system 12 that represents an assessment by the user as to the extent to which the user possesses the corresponding personality quality of the personality qualities 62. The user's responses are indicated using the input controls 64, are transmitted to the assessment server 14, and are stored and processed by the testing module 18.

The personality qualities 62 included in the self evaluation screen 60 can be identical to the personality qualities 26 that were previously presented to the user 13 in the ideal service provider evaluation screen 24. This allows the exercise presented by the self evaluation screen 60 to be contrasted against the earlier task of evaluating an ideal service provider, in the exercise presented by the ideal service provider evaluation screen 24. Also, by having the user 13 complete an intervening activity, such as the service judgment scenarios, between presentation of the ideal service provider screen 24 and the self evaluation screen 60, the likelihood that the user 13 will artificially tailor their responses to the self evaluation screen 60 to match their responses to the ideal service provider screen 24 is decreased.

Upon conclusion of the assessment test, the inputs that were received by the assessment sever 14 are processed to generate as output a score indicative of the user's ability to provide customer service or client service based on the inputs. The score is calculated based on three main components that are derived from the inputs: the user's past experiences, the user's personality, and the user's ability to make and understand service judgments. As an example, a component score relating to past experiences is calculated based on the inputs received from the past experiences input screen. A component score relating to service judgments is calculated based on inputs received during presentation of the service judgment scenarios. A component score relating to personality can be calculated based on the inputs received during presentation of the ideal service provider evaluation screen 24 and the self evaluation screen 60. The component scores can be calculated in any desired manner, such as by calculating a deviation of each input from a base line response and subtracting the deviation of each input from a maximum possible value to produce the component score. These component scores are used to calculate the score indicative of the user's ability to provide customer service or client service. This calculation can be made in any suitable manner, such as by calculating a weighted average of the component scores. The score can be calculated and delivered to the prospective employer system 10 by the reporting module 22 of the assessment server 14.

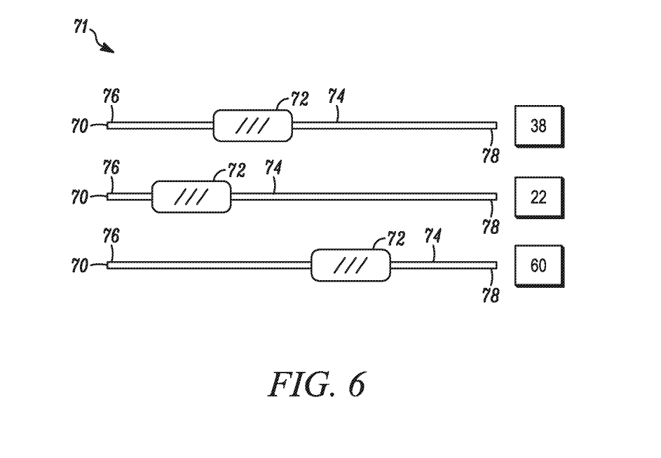

The input controls utilized by various screens of the assessment test can be configured to receive a value that falls within a predetermined range. As an example, the input received from the user is often a value between 0 to 100. This input is entered via standard personal computer input devices and a GUI presented by the candidate system 12. Specifically, a representation of a control device that is movable in response to user-actuated input is used to gather the most of the previously described inputs. For example, the control device is in the form of a slider bar control 70 that is displayed by the candidate system 12 as part of a slider bar control grouping 71, as shown in FIG. 6. As the user 13 moves the mouse or other control associated with the candidate system 12, the position of a slider element 72 moves along a bar 74 between a first extent 76 of the bar 74 and a second extent 78 of the bar 74. By manipulating the slider element 72, the individual can input a response of between a minimum value, such as zero, to a maximum value, such as 100. The minimum value is selected when the slider element 72 is positioned at the first extent 76 of the bar 74 and the maximum value is selected when the slider element is positioned at the second extent 78 of the bar 74. The slider bar control 70 can be configured to prevent identical numbers from being entered with respect to two or more instances of the slider bar control 70 in the grouping 71.

By forcing the individual to move the slider bar control 70 for each answer, the risk of individuals falling into “response rut” or a response set is reduced. Response rut occurs when an individual responds to a series of multiple-choice or rating response question with the same answers or very similar answers. For example, an individual might enter “3” repeatedly for every item in a five-item scale. The use of the slider bar control with a rating range of 0-100 encourages individuals to be more precise, deliberate, and intentional with their response behaviors, allowing for greater sensitivity in the ratings and increasing the chance that final scores based on data from these sources will be more easily distinguishable across multiple individuals. The intuitive nature of the slider bar control 70 also makes responding easier for the user 13, as it is clear that closer to zero represents less likely or a lower rating and closer to 100 represents a more likely or a higher rating. This is a clearer approach to assessment than asking individuals to distinguish between arbitrary rating anchors such as “Somewhat likely” and “Moderately likely” or “Slightly likely”.

Where a grouping of the slider bar controls are presented, such as in the ideal service provider evaluation screen 24, the slider bar controls 70 in the grouping can be configured to prevent two of the slider bar controls in the grouping from being set to the same value. This further prevents the inputs that are submitted by the user 13 from exhibiting a “response rut” pattern.

The graphical representation 32 that is presented during each service judgment scenario will now be described in more detail. Each graphical representation 32 depicts a work scenario that occurs at least in part on the premises of the prospective employer 11. The graphical representation 32 includes hand-drawn images of graphics depicting the service provider 36 and the customer 34 in the environment 38, which is representative, at least in part, of a facility used by the prospective employer 11, such as the employer's place of business. The hand drawn images are two dimensional images that rendered by a person using drawing tools that allow control over the final representation of the image. The hand drawn images are stored in a computer readable format, such as GIF, JPEG or other suitable formats. As one example, the hand-drawn images can be drawn by an artist using a digital pen tablet and either raster or vector based painting or illustration computer software. As another example the hand drawn images could comprise or be based upon images drawn on paper or other suitable media and then digitized using conventional means such as a scanner. Computer rendered images based upon mathematical representations of three dimensional geometry are expressly excluded from the scope of hand drawn images.

Each graphical representation 32 can be configured by changing the race, gender, clothing or position of the persons depicted in the scenario. For example, a service provider 36 depicted in the graphical representation 32 can be shown wearing the official uniform of the prospective employer 11. The graphical representations 32 also allow for branding and organizational cues that enhance the role playing capabilities of the assessment test.

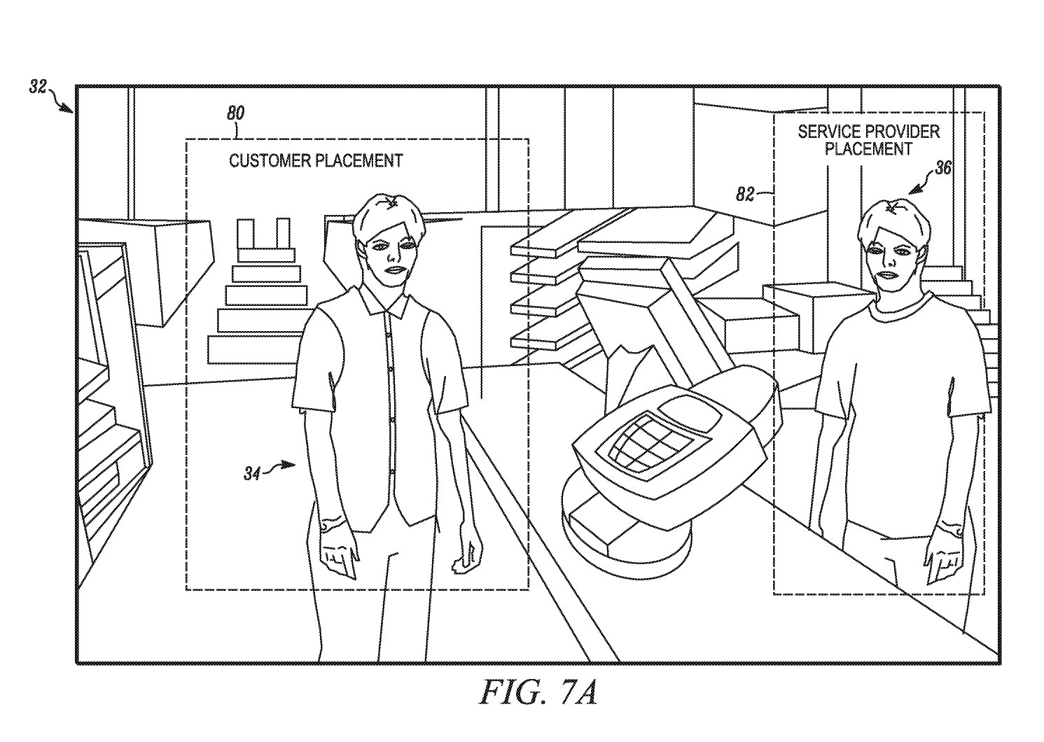

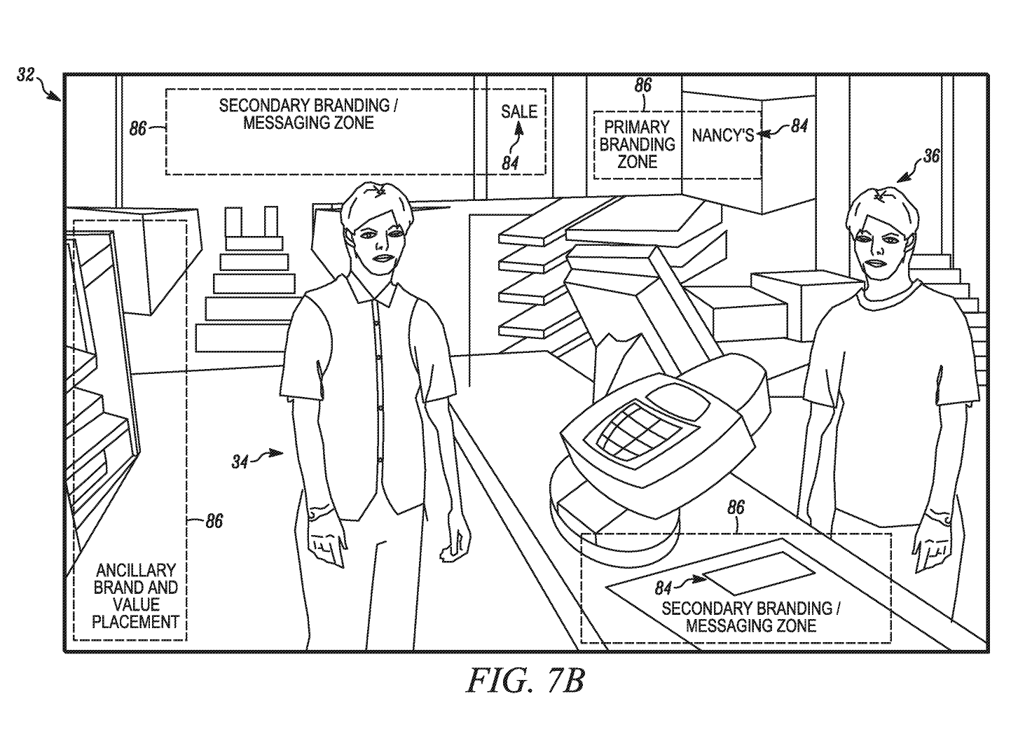

The graphical representations 32 can be standardized. As an example, the customer 34 is consistently placed within a predefined customer placement zone 80 and the service provider 36 is consistently placed within a predefined service provider placement zone 82, as shown in FIG. 7A. The customer placement zone 80 and the service provider placement zone 82 are spaced from one another laterally across the image. For example, with the customer placement zone 80 and the service provider placement zone 82 can each be positioned adjacent to a respective side of the graphical representation 32. As a further example of standardization, the customer 34 and the service provider 36 are depicted using consistent sizes, placements and perspectives.

The graphical representations 32 can each depict a visual attribute of the prospective employer 11. The visual attribute of the prospective employer 11 can be one or more of trade dress, brand, facility decor, products or employee uniform. As an example, the environment 38 can depict the facility of the prospective employer 11. As another example, the branding elements 84 can be placed in predefined branding placement zones 86, as shown in FIG. 7B. The visual attribute can also provide cues as to the values, mission, and competency of the prospective employer 11. As an example, if the prospective employer 11 is a research hospital, the environment 38 can be designed to provide visual cues that reinforce perceptions regarding the research competency of the hospital.

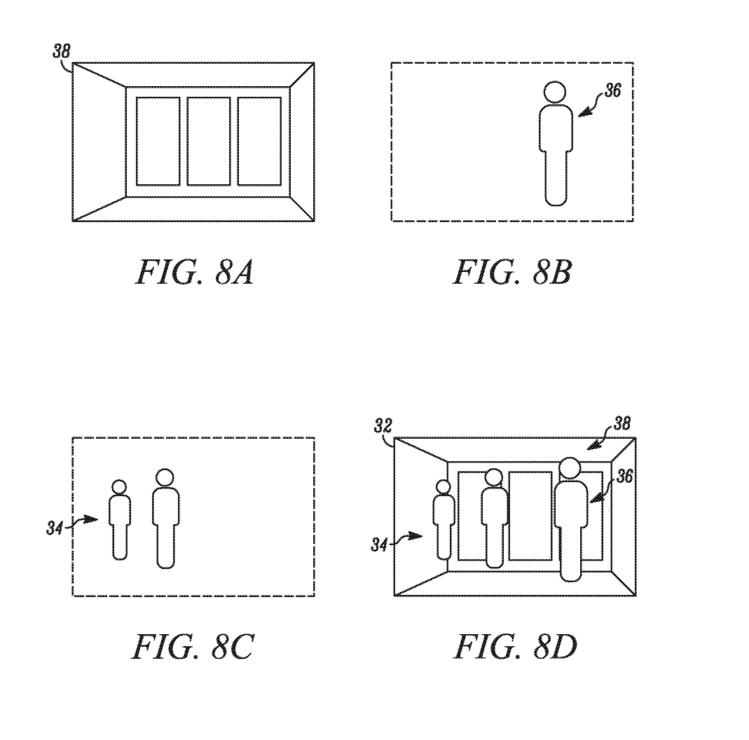

As shown in FIGS. 8A-8D, the graphical representations 32 can constructed from individual hand-drawn graphics that are assembled into a composite image depicting a work scenario occurring at least in part on the premises of the specified employer. As an example, the environment 38 (FIG. 8A), the service provider 36 (FIG. 8B), and the customer 34 (FIG. 8C) can each be separate graphic elements that are contained in separate image files. The separate image files can be partially transparent images to allow for compositing. Other features, such as the branding elements 84, can be provided as graphic elements that are contained in separate image files. The graphical elements are composited to form the graphical representation (FIG. 8D).

The graphical content of the assessment test can be either or both of configurable and customizable. Configuration and customization can be controlled by the prospective employer 11 using the authoring module 22, thereby allowing the prospective employer 11 to dictate the context of each of the service judgment scenarios. This can include configuring the scenarios by choosing the graphic elements that will be incorporated into the graphical representations 32 from predefined resource libraries that are associated with the assessment server 14. This allows the prospective employer 11 to quickly and conveniently design the graphical representations 32 from predefined graphic elements. Optionally, the service judgment scenarios can include graphic elements that are customized to display visual attributes that are associated with the prospective employer 11. This can include creation of custom graphic elements that represent or are associated with the prospective employer. As one example, the prospective employer 11 can customize the scenarios by creation of customized graphic elements that resemble a facility used by the prospective employer 11.

The authoring module 22 includes an interface that allows the employer 11 to select the graphic elements corresponding to the customer 34, the service provider 36, and the environment 38. This can be in the form of a web page that is generated by the authoring module 22, transmitted to the prospective employer system 10, and displayed by the prospective employer system 10. Available graphic elements are displayed, and can be selected by the employer 11 for use as the graphic elements corresponding to the customer 34, the service provider 36, and the environment 38. The available graphic elements can allow selection of the gender, ethnicity, dress, etc. of the customer 34 and the service provider 36. Similarly, the available graphic elements can allow selection of the environment 38 to be representative of a facility used by the prospective employer 11, such as the premises of or place of business of the prospective employer 11. Other graphic elements can be selected for inclusion in the graphic representation 32. The additional graphic elements can include the branding elements 84, and other logos, props and decorations. Logos, branding, and photo references for the environment 38 can be submitted to the assessment server 14 by the employer 11 to allow for further customization of the graphic elements.

The assessment server 14 then assembles them into a single image that will serve as the graphical representation 32. As an example, the graphic elements can be combined at using a server side at API or software package that is operable to layer the selected graphic elements, and flatten the graphic elements into the single image that will serve as the graphical representation 32. This image is indexed and saved by the authoring module 22 for later use by the assessment module 18 as part of the assessment test.

By way of customization of the graphical representations 32, the assessment test can be deployed across a variety of industries and for multiple job positions across multiple levels within a single organization. In addition, other portions of the assessment test, such as the past experiences input screen, the ideal service provider evaluation screen 24, and the self evaluation screen 60 can be configured so that they are non-industry specific, so that the assessment test can be deployed in any industry without reconfiguration of these sections.

The authoring module 22 can further allow the prospective employer to fine tune the scoring performed by the assessment server. For example, the authoring module can be configured to allow the prospective employer to set ideal values for each of the inputs that are to be supplied by the user, or to set minimum and maximum acceptable ranges for the inputs that are to be supplied by the user.

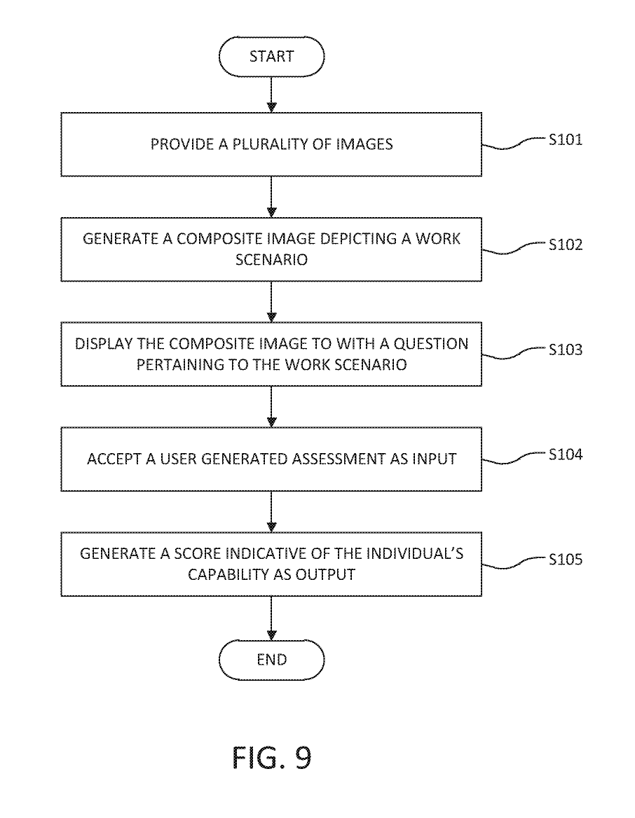

An exemplary method for evaluating at least one capability of an individual seeking or holding a job with a specified employer will now be explained with reference to FIG. 9.

In Step S101, a plurality of images are provided. The images include at least one graphic element depicting the service provider 36, at least one graphic element depicting the customer 34 of the prospective employer 11, and at least one graphic element depicting the environment 38, which at least partially represents a facility used by the prospective employer 11, such as a place of business of the prospective employer 11.

The process proceeds to Step S102, which includes generating a composite image, such as the graphical representation 32, which includes the plurality of images of Step S101. The composite image depicts a work scenario that occurs at least in part in a facility used by the prospective employer, such as on the premises of the prospective employer 11.

Step S103 includes causing the composite image to be displayed with at least one question pertaining to the work scenario, such as the judgment question 42, and a plurality of candidate responses, such as the candidate responses 44, to the at least one question.

In Step S104, at least one user generated assessment of at least one of the plurality of candidate responses is accepted as input. In Step S105, a score indicative of the individual's capability based on the at least one user-generated assessment is generated as output.

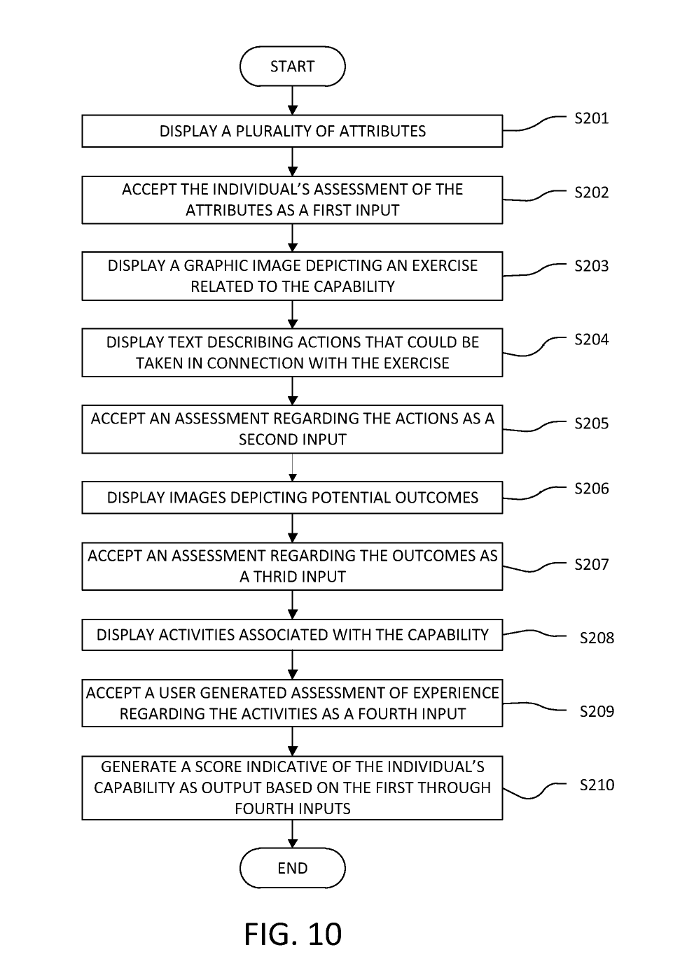

A computer implemented method for testing at least one capability of an individual will now be explained with reference to FIG. 10.

In Step S201, a plurality of attributes previously associated with the capability are displayed on a computer monitor, which is used herein broadly to referred to any type of display that is associated with a fixed or mobile computing device. In Step S102, the individual's assessment of the relative importance of each of the attributes to the capability is accepted as a first input.

In Step S203, a graphic image depicting an exercise related to the capability is displayed on a computer monitor. In Step S204, text describing a plurality of alternative actions that could be taken in connection with the exercise that is displayed on the computer monitor. In Step S205, an assessment by the individual with respect to each of the plurality of alternative actions is accepted as a second input.

In Step S206, a plurality of graphic images are displayed on a computer monitor. The graphic images each depict a potential outcome to at least one of the plurality of alternative actions. In Step S207, an assessment by the individual of the likelihood of occurrence of each potential outcome is accepted as a third input.

In Step S208, a plurality of activities associated with the capability are displayed on the computer monitor. At least some of the activities require for their proper performance at least one or more of the plurality of attributes. In Step S209, a user generated indication of the individuals experience in performing each of the plurality of activities is accepted as a fourth input.

In Step S210, a score indicative of the individual's capability is generated and based on the first, second, third, and fourth inputs and is provided as an output.

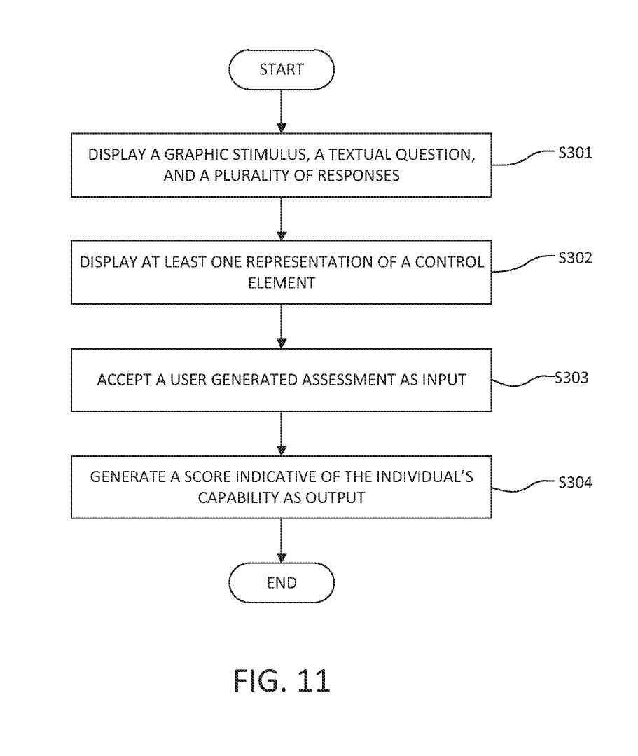

A computer implemented method for evaluating at least one capability of an individual seeking or holding employment will now be explained with reference to FIG. 11.

In Step S301, a graphic stimulus, a textual question pertaining to the graphics stimulus, and a plurality of responses to the textual question are displayed on a monitor. In Step S302, at least one representation of the control element that is movable in response to a user-actuated input device to one or more positions each indicative of a user-generated assessment is displayed on the monitor. In Step S303, at least one user-generated assessment for at least one of the plurality of responses is accepted as input. In Step S304, a score indicative of the individual's capability is generated an output based on the user-generated assessment.

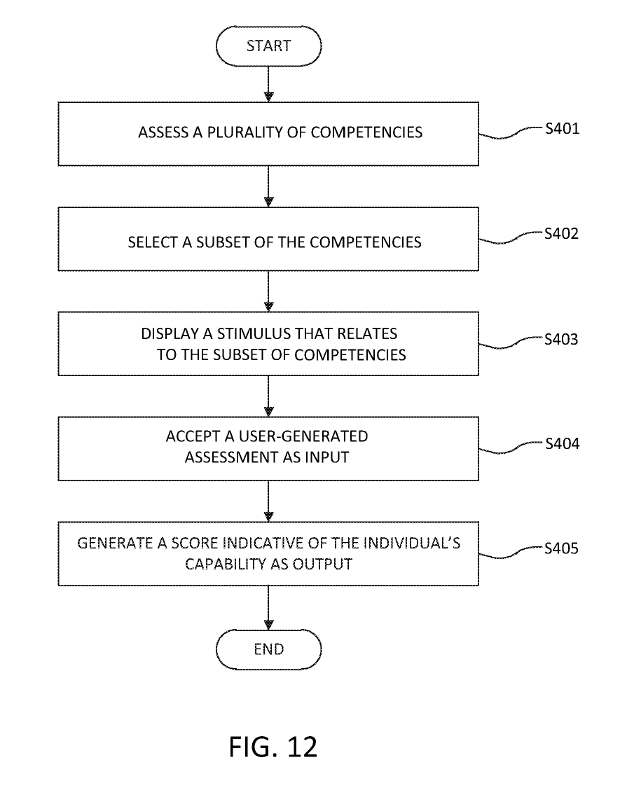

A universal competency assessment method for evaluating at least one capability of an individual seeking or holding a job with a specified employer will now be explained with reference to FIG. 12.

In Step S401, an assessment is made as to a plurality of competencies to determine the degree to which each competency is able to predict whether the individual possesses the capability. This assessment is made without regard to the nature or industry of the job with the specified employer. In Step S402, a subset of the competencies is selected based on ability of each competency to predict whether the individual possesses the capability. The capability can be the ability of the individual to provide service, in which case the competencies are selected so that they are able to predict the extent to which the individual possesses the capability without regard to the particular industry to which the job with the specified employer relates. Thus, the subset of competencies can be utilized as a basis for an assessment test that is universally competent, i.e. able to assess the individual's aptitude with respect to the capability without the need for modifications to the assessment test in order to tailor the assessment test to a particular job or industry.

In the context of an assessment test that is based upon the subset of attributes, in Step S403, a stimulus is displayed to the individual. The stimulus relates to the subset of attributes that were selected in Step S402. The stimulus can be graphical, textual, or a combination of graphical and textual. For example, the stimulus can include one or more evaluation screens are displayed to the individual, such as the past experiences input screen, the ideal service provider evaluation screen, the service judgment scenario screens, and the self evaluation screen. In Step S404, one or more inputs are accepted from the individual. The input is at least one user-generated assessment that is relevant to each competency of the subset of competencies, and is made in response to the stimulus that is displayed in Step S403.

In Step S405, a score indicative of the individual's capability is generated as an output based on based on the at least one user-generated assessment.

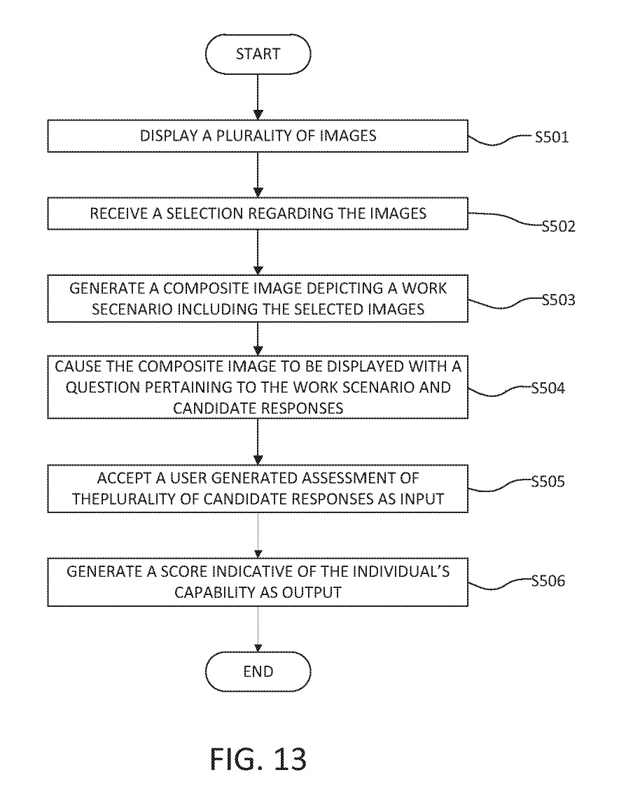

An exemplary method for evaluating at least one capability of an individual seeking or holding a job with a specified employer will now be explained with reference to FIG. 13.

In Step S501, a plurality of images are caused to be displayed. This can be performed by the assessment server 14 sending the images as part of a web page that is transmitted to the prospective employer system 10. The images include a plurality of graphic elements depicting the service provider 36, a plurality of graphic elements depicting the customer 34 of the prospective employer 11, and a plurality of graphic elements depicting the environment 38, which at least partially represents facility used by the prospective employer 11, such as a place of business of the prospective employer 11.

In step S502, a selection is received regarding the plurality of images. The selection identifies at least one graphic element depicting the service provider 36, at least one graphic element depicting the customer 34, and at least one graphic element depicting the environment 38.

The process proceeds to Step S503, which includes generating a composite image, such as the graphical representation 32, which includes the images that were identified in Step S502. The composite image depicts a work scenario that occurs at least in part on the premises of the prospective employer 11.

Step S504 includes causing the composite image to be displayed with at least one question pertaining to the work scenario, such as the judgment question 42, and a plurality of candidate responses, such as the candidate responses 44, to the at least one question.

In Step S505, at least one user generated assessment of at least one of the plurality of candidate responses is accepted as input. In Step S506, a score indicative of the individual's capability based on the at least one user-generated assessment is generated as output.

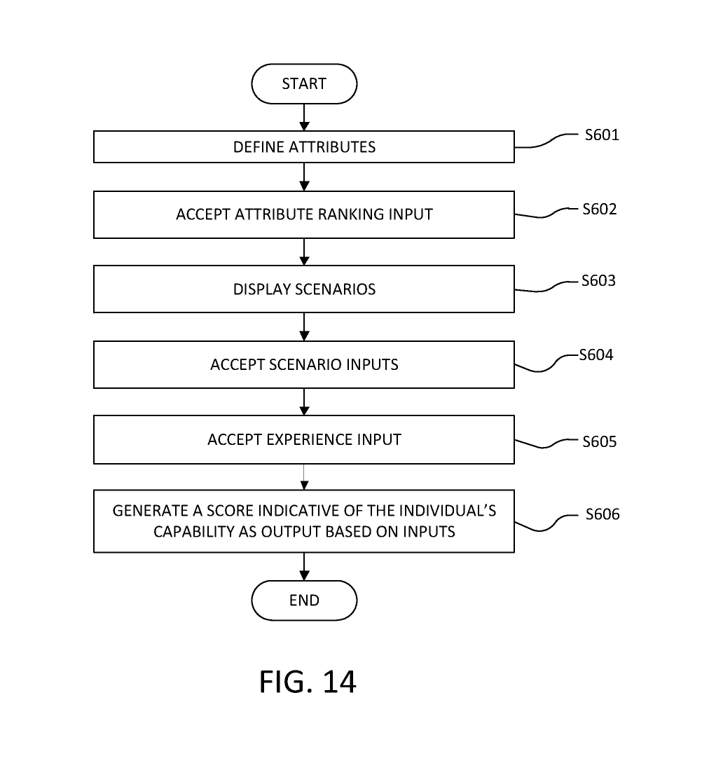

A method for evaluating at least one capability of an individual seeking or holding a job with a specified employer will now be explained with reference to FIG. 14.

In Step S601, a plurality of attributes that are associated with the capability are defined. The attributes can be non-industry specific. In Step S602, an attribute ranking input is accepted, which represents a user generated assessment of the relative importance of each of the plurality of attributes.

In Step S603, each of a plurality of scenarios are displayed. In Step S604, one or more scenario inputs are accepted. The scenario inputs represent user generated responses to the plurality of scenarios, wherein the scenario inputs are relevant to one or more of the attributes.

In Step S605, an experience input is accepted. The experience input represents a user generated indication of the individual's experience in performing each of a plurality of activities. At least some of the activities require for their proper performance at least one or more of the plurality of attributes.

In Step 606, a score indicative of the individual's capability is generated as an output based on the attribute ranking input, the scenario inputs and the experience input.

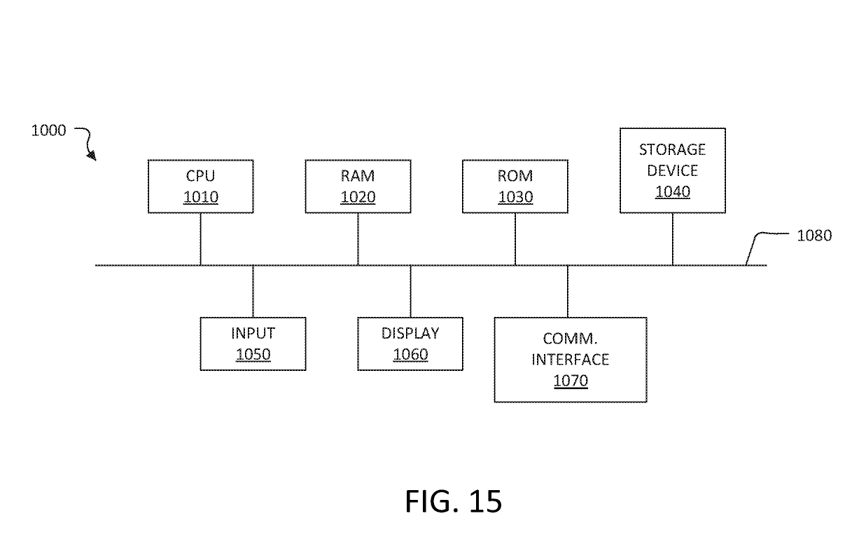

Each of the prospective employer system 10, the candidate system 12 and the assessment server 14 can be implemented in the form of software suitable for performing the processes detailed herein that is executed by a separate conventional computer 1000, as shown in FIG. 15. The computer 1000 can be any suitable conventional computer. As an example, the computer 1000 includes a processor such as a central processing unit (CPU) 1010 and memory such as RAM 1020 and ROM 1030. A storage device 1040 can be provided in the form of any suitable computer readable medium, such as a hard disk drive. One or more input devices 1050, such as a keyboard and mouse, a touch screen interface, etc., allow user input to be provided to the CPU 1010. A display 1060, such as a liquid crystal display (LCD) or a cathode-ray tube (CRT), allows output to be presented to the user. A communications interface 1070 is any manner of wired or wireless means of communication that is operable to send and receive data or other signals using the network 16. The CPU 1010, the RAM 1020, the ROM 1030, the storage device 1040, the input devices 1050, the display 1060 and the communications interface 1070 are all connected to one another by a bus 1080.

As previously noted, the network 16 allows communication between the prospective employer system 10, the candidate system 12 and the assessment server 14. The network 16 can be, for example, be the internet, which is a packet-switched network, a local area network (LAN), wide area network (WAN), virtual private network (VPN), a wireless data communications system of any type, or any other means of transferring data. The network 16 can be a single network, or can be multiple networks that are connected to one another. It is specifically contemplated that the network 16 can include multiple networks of varying types. For example, the candidate system 12 can be connected to the assessment server 14 by the internet in combination with local area networks on either or both of the client-side or the server-side.

While a single candidate system 12 has been described, it should be understood that multiple clients can simultaneously connect to the assessment server 14. Furthermore, while a single assessment server 14 has been described, it should be understood that the functions of the assessment server 14 can be distributed among a plurality of conventional computers, such as the computer 1000, each of which are capable of performing some or all of the functions of the assessment server 14.

The description herein has been made with reference to an exemplary system in which the assessment test is generated by the assessment server 14 and is transmitted to and administered by the candidate system 12. The assessment test can be generated and administered by systems other than a client-server system. As an example, the assessment software or portions of the assessment software, such as the testing module 18, could be resident on the computer utilized to administer the assessment test. In such a system, the results of the test could be compiled and reviewed on the same computer. Alternatively, the user inputs and/or the results of the assessment test could be transmitted to another computer for review and/or processing.

The description herein has been made with reference to assessment of a user's capability to provide customer service or client service. It should be understood, however, that the systems and methods described herein can also be applied to assessment of other capabilities.

While the disclosure is directed to what is presently considered to be the most practical embodiments, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

1. A computer-implemented method for testing at least one capability of an individual, comprising:
displaying on a computer monitor a plurality of attributes previously associated with the capability;
accepting as a first input for each of the plurality of attributes the individual's assessment of the relative importance of the attribute to the capability;
displaying on a computer monitor a graphic image depicting an exercise related to the capability;
displaying text describing a plurality of alternative actions that could be taken in connection with the exercise;
accepting as a second input an assessment by the individual with respect to each of the plurality of alternative actions;
displaying on the computer monitor a plurality of graphic images each depicting a potential outcome to at least one of the plurality of alternative actions;
accepting as a third input an assessment by the individual of the likelihood-of-occurrence of each potential outcome;
displaying on the computer monitor a plurality of activities associated with the capability, wherein at least some of the activities require for their proper performance at least one or more of the plurality of attributes;
accepting as a fourth input a user-generated indication of the individual's experience in performing each of the plurality of activities; and
generating as output a score indicative of the individual's capability based on the first, second, third and fourth inputs.

2. The method of claim 1, further comprising:
generating the graphic image depicting an exercise related to the capability as a composite image including a plurality of images, the plurality of images including at least one graphic element depicting a service provider, at least one graphic element depicting a customer of a specified employer, and at least one graphic element depicting an environment that at least partially represents a place of business of the specified employer, wherein the composite image depicts a work scenario occurring at least in part at the facility used by the specified employer.

3. The method of claim 1, wherein the step of accepting as the first input for each of the plurality of attributes the individual's assessment of the relative importance of the attribute to the capability and the step of accepting as the fourth input the user-generated indication of the individual's experience in performing each of the plurality of activities are separated by an intervening activity.

4. The method of claim 3, wherein the intervening activity includes the steps of accepting as the second input the assessment by the individual with respect to each of the plurality of alternative actions and accepting as the third input the assessment by the individual of the likelihood-of-occurrence of each potential outcome.

5. A method for evaluating at least one capability of an individual seeking or holding a job with a specified employer, comprising:
providing a plurality of images including at least one graphic element depicting a service provider, at least one graphic element depicting a customer of the specified employer, and at least one graphic element depicting an environment that at least partially represents a facility used by the specified employer, wherein at least one of the plurality of images depicts a visual attribute of the specified employer;
generating a composite image including the plurality of images, the composite image depicting a work scenario occurring at least in part at the facility used by the specified employer;
causing the composite image to be displayed with at least one question pertaining to the work scenario and a plurality of candidate responses to the at least one question;
accepting as input at least one user-generated assessment of at least one of the plurality of candidate responses; and
generating as output a score indicative of the individual's capability based on the at least one user-generated assessment.

6. The method of claim 5, wherein the visual attribute of the specified employer includes at least one of the specified employer's trade dress, brand, facility decor, products, or employee uniform.

7. The method of claim 5, wherein the visual attribute of the specified employer includes at least one of the specified employer's values, mission, and competency.

8. The method of claim 5, wherein the plurality of images are digital hand-drawn images.

9. The method of claim 5, wherein the at least one user-generated assessment of at least one of the plurality of candidate responses represents a likelihood that the individual would select the candidate response.

10. The method of claim 5, further comprising:
providing a description of the work scenario with the composite image.

11. The method of claim 5, wherein the at least one question pertaining to the work scenario includes a first question regarding a judgment by the service provider and a second question regarding a reaction by the customer of the specified employer.

12. A computer-implemented method for evaluating at least one capability of an individual seeking or holding employment, comprising:
displaying on a monitor a graphic stimulus, a textual question pertaining to the graphic stimulus and a plurality of responses to the textual question;
displaying on the monitor at least one representation of a control element that is movable in response to a user-actuated input device to one or more positions each indicative of a user-generated assessment;
accepting as input at least one user-generated assessment for at least one of the plurality of responses; and
generating as output a score indicative of individual's capability based on the user-generated assessment.

13. The method of claim 12, wherein the at least one representation of a control element is movable continuously along a range of values from a minimum value to a maximum value.

14. The method of claim 12, wherein the at least one representation of a control element is a depiction of a slider bar control.

15. A method for evaluating at least one capability on of an individual seeking or holding a job with a specified employer, comprising:
defining a plurality of attributes that are associated with the capability;
accepting an attribute ranking input representing a user generated assessment of the relative importance of each of the plurality of attributes;
displaying a plurality of scenarios;
accepting one or more scenario inputs representing user generated responses to the plurality of scenarios, wherein the scenario inputs are relevant to one or more of the attributes;
accepting an experience input representing a user generated indication of the individual's experience in performing each of a plurality of activities, wherein at least some of the activities require for their proper performance at least one or more of the plurality of attributes; and
generating as output a score indicative of the individual's capability based on the attribute ranking input, the scenario inputs and the experience input.

16. The method of claim 15, wherein the attributes are non-industry specific.

17. The method of claim 15, wherein each scenario of the plurality of scenarios includes one or more graphic elements depicting a visual attribute of the specified employer

18. The method of claim 17, wherein the visual attribute of the specified employer includes at least one of the employer's trade dress, brand, facility decor, products or employee uniform.

19. The method of claim 15, wherein the step of accepting an attribute ranking input includes displaying a plurality of slider bar controls each corresponding to one of the attributes.

20. A computer-implemented method for evaluating at least one capability of an individual seeking or holding employment with a specified employer, comprising:
displaying on a computer monitor a graphic image depicting an interaction between a service provider and a customer of the employer;
displaying text describing a plurality of alternative actions that could be taken by the individual during the depicted interaction;
accepting as a first input an assessment with respect to each of the plurality of alternative actions;
displaying on the computer monitor a plurality of graphic images each depicting a potential reaction by the customer to at least one of the plurality of alternative actions;
accepting as a second input an assessment by the individual of the likelihood-of-occurrence of each potential reaction; and
generating as output a score indicative of individual's capability based on the first input and the second input.

21. The method of claim 20, wherein each scenario of the plurality of scenarios includes one or more graphic elements depicting a visual attribute of the specified employer

22. The method of claim 21, wherein the visual attribute of the specified employer includes at least one of the employer's trade dress, brand, facility decor, products or employee uniform.

23. The method of claim 20, wherein the assessment with respect to each of the plurality of alternative actions represents a likelihood that the individual would select each alternative action.

24. A universal competency assessment method for evaluating at least one capability of an individual seeking or holding a job with a specified employer, comprising:
assessing a plurality of competencies to determine the degree to which each competency is able to predict whether the individual possesses the capability without regard to the nature or industry of the job with the specified employer;
selecting a subset of the competencies based on ability of each competency to predict whether the individual possesses the capability;
accepting as input at least one user-generated assessment that is relevant to each competency of the subset of competencies; and
generating as output a score indicative of the individual's capability based on the at least one user-generated assessment.

25. The method of claim 24, wherein the each competency of the subset of competencies is non-industry specific.

26. The method of claim 24, further comprising:
displaying on a computer monitor each attribute of the subset of attributes, wherein the at least one user-generated assessment relates to the individual's assessment of the relative importance of the attribute to the capability.

27. The method of claim 24, further comprising:
displaying on a computer monitor each attribute of the subset of attributes, wherein the at least one user-generated assessment is the individual's self-assessment with respect to each attribute of the subset of attributes.

28. The method of claim 24, further comprising:
displaying on a monitor a graphic stimulus, a textual question pertaining to the graphic stimulus and a plurality of responses to the textual question, wherein the at least one user generated assessment regards at least one of the plurality of responses to the textual question.
